(19) United States
(12) Patent Application Publication
(10) Pub. No.: US 2010/0066323 A1
(43) Pub. Date: Mar. 18, 2010

(54) SYSTEM AND METHOD FOR PROVIDING PULSE FREQUENCY MODULATION MODE

(75) Inventor: Zaki MOUSSAOUI, San Carlos, CA (US)

Correspondence Address: HOWISON & ARNOTT, L.L.P, P.O. BOX 741715, DALLAS, TX, 75374-1715, US

(73) Assignee: INTERSIL AMERICAS INC., Milpitas, CA (US)

(21) Appl. No.: 12/506,672

(22) Filed: Jul. 21, 2009

Related U.S. Application Data
(60) Provisional application No. 61/098,140, filed on Sep. 18, 2008.

(51) Int. Cl. G05F 1/10

(52) U.S. Cl. 323/282

(57) ABSTRACT

A voltage regulator comprises switching circuitry for generating a phase voltage at a phase node responsive to an input voltage and switching control signals. An inductor is connected to the phase node and an output voltage node. A capacitor is connected between the output voltage node and ground. An error amplifier generates an error voltage responsive to an output voltage from the output voltage node and a reference voltage. Switching control circuitry generates switching control signals to the switching circuitry responsive to the error voltage, a ramp voltage and an established voltage level. The switching control circuitry operates the voltage regulator in a pulse frequency modulation mode of operation after sampling the error voltage and setting the established voltage level and exits the pulse frequency modulation mode of operation when the error voltage falls below the established voltage level.

### CROSS-REFERENCE TO RELATED APPLICATIONS

This application claims priority from U.S. Provisional Patent Application No. 61/098,140, filed Sep. 18, 2008, entitled SYSTEM AND METHOD FOR PROVIDING PULSE FREQUENCY MODULATION MODE, which is incorporated herein by reference.

### BRIEF DESCRIPTION OF THE DRAWINGS

For a more complete understanding, reference is now made to the following description taken in conjunction with the accompanying Drawings in which:

FIG. 1 is a block diagram of a voltage regulator;

FIG. 2 is a block diagram of the circuitry for providing control of the pulse frequency modulation mode of operation of a voltage regulator such as that illustrated in FIG. 1;

FIG. 3 illustrates various wave forms generated within the circuitry of FIG. 2;

FIG. 4 illustrates the transition from pulse frequency modulation mode to fixed frequency modulation mode of operation;

FIG. 5 illustrates switching frequency improvements provided using the circuitry of FIG. 1; and

FIGS. 6a and 6b are flow diagrams describing the operation of the circuitry of FIG. 2.

### DETAILED DESCRIPTION

Referring now to the drawings, wherein like reference numbers are used herein to designate like elements throughout, the various views and embodiments of a system and method for providing pulse frequency modulation mode are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

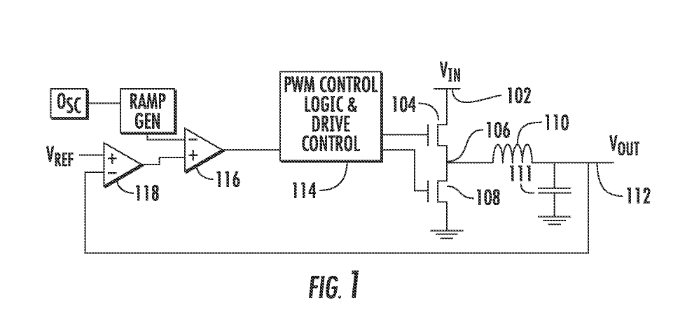

Referring now to the drawings, and more particularly to FIG. 1, there is illustrated a block diagram of a buck regulator voltage regulation circuit. An input voltage V_{IN} is applied at node 102. The V_{IN} voltage is applied across an upper gate switching transistor 104 that has its drain/source path connected between node 102 and a phase node 106. A lower gate switching transistor 108 has its drain/source path connected between phase node 106 and the ground node. An inductor 110 is connected between the phase node 106 and an output voltage node 112. A capacitor 111 is connected between the output voltage node 112 and ground. The output voltage node 112 provides the regulated voltage from the voltage regulation circuit.

The upper gate switching transistor 104 and lower gate switching transistor 108 have their gates connected to PWM logic and drive control circuitry 114. The PWM control logic and drive control circuitry 114 generate the gate control signals for turning on the upper gate transistor 104 and the lower gate transistor 108 responsive to a output of a PWM comparator 116. The PWM comparator 116 generates a PWM control signal to the PWM control logic and drive control circuitry 114 responsive to a ramp wave form provided to its inverting input and a voltage error signal provided to its non-inverting input. The voltage error signal is generated by an error amplifier 118. The error amplifier 118 generates the voltage error signal responsive to a reference voltage provided to its non-inverting input and a voltage feedback signal provided from the output voltage node 112 applied to its inverting input.

Voltage regulation devices often require the operation of pulse frequency modulation mode during light load conditions at the output voltage node 112. Within existing methods, when a regulator moves from a pulse frequency modulation (PFM) mode of operation to a fixed frequency mode of operation, large overshoot or undershoot conditions occur depending upon the particular method of switching between PFM mode and fixed frequency mode of operation. For example, some systems are based upon a hysteretic loop that holds the regulator in open mode during the PFM mode of operation. When the regulator needs to close the loop, there is no guarantee that the compensation output is where it needs to be. This can cause erratic behavior in the operation of the system.

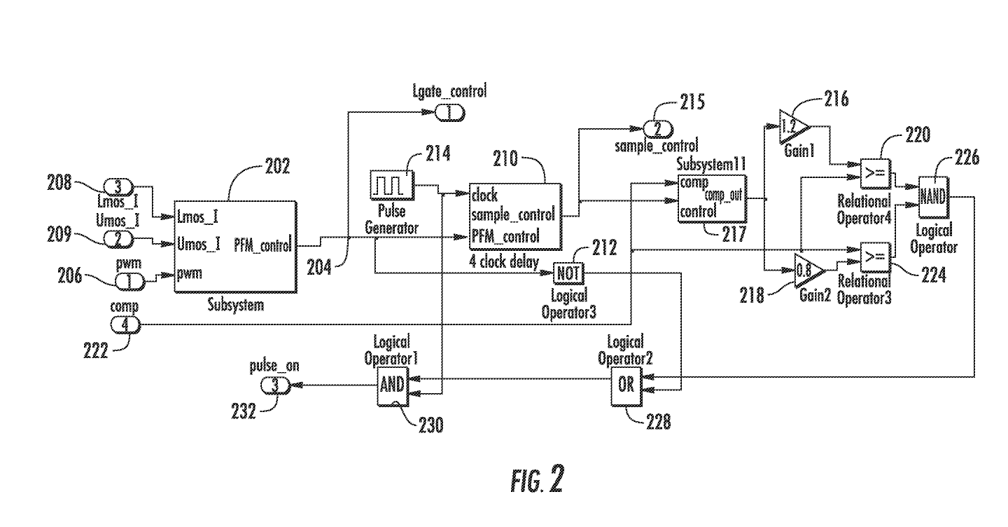

Referring now to FIG. 2, there is illustrated a block diagram of the circuitry for generating pulse frequency modulation control signals. The PFM control signal logic 202 generates a PFM control signal (PFM_CONTROL) that is provided to node 204. The PFM control signal logic 202 generates the PFM control signal indicating when to enter the PFM mode of operation based upon a programmed current load level responsive to the current through the lower switching transistor provided at node 208, the current from the upper switching transistor provided at node 209 and the PWM control signal provided at node 206. The PFM control signal provided at node 204 indicates when the PFM mode of operation is entered. This causes the buck regulator circuit of FIG. 1 to go in the diode emulation mode of operation. This causes the lower switching transistor 108 to be turned off. The PFM control signal is provided to the gate of lower switching transistor 108 to turn off the lower switching transistor and place the circuit in the diode emulation mode of operation. The PFM control signal is generated responsive to a PWM signal provided at node 206 from the PWM comparator 116. Additionally, the PFM control signal is responsive to current control signals from the lower switching transistor 108 at node 208 and the upper gate switching transistor 104 provided at node 209. The PFM control signal from the PFM control logic 202 is input to a clock delay circuit 210 and to the input of an inverter 212.

The clock delay circuit 210 delays the PFM control signal provided from PFM control signal logic 202 to enable the system to settle as it goes into diode emulation before the COMP signal is sampled at block 214. Sample block 217 samples the COMP signal provided to the sample block 217 via node 222 responsive to the sample control signal provided from the delay circuit 210. The clock delay circuit 210 is also connected to receive a clock input from pulse generator 214 to measure the delay. The sample control output of the clock delay circuit 210 is provided as a control input to a sample block 217. The sample control output is also provided at node 215. The other input of sample block 217 is connected to node 222 to receive a COMP signal from the error amplifier. A second input of sample block 217 is connected to receive the voltage error signal from the output of the error amplifier 118.

The output of the sample block 217 is provided as an input to gain amplifier 216 and gain amplifier 218. The sample block 217 generates the COMP_OUT signal. The COMP_OUT signal is generated before going into the PFM mode of operation while the device is within the diode emulation mode. The sample block 217 samples the voltage error signal (COMP signal) and holds it for a programmed period of time. This delayed value is multiplied by a programmed value to generate the COMP_MAX signal at the output of gain amplifier 216. The output of gain amplifier 216 is provided to a relational operator 220. The relational operator 220 determines if the output of the amplifier 216 is greater than or equal to the value of the voltage error signal from the error amplifier provided at node 222. The output (COMP_MIN) of the gain amplifier 218 is provided to a relational operator 124. Relational operator 124 determines if the output of the gain amplifier 218 is greater than or equal to the error amplifier voltage provided at node 122 from the error amplifier. The output of the relational operators 120 and 124 are provided to the inputs of NAND gate 226. The output of NAND gate 226 is provided as an input to OR gate 128. The other input of OR gate 228 is connected to the output of inverter 212 which is inverting the input of the PFM control signal logic 202. The output of OR gate 228 is connected to one input of AND gate 230. The second input of AND gate 230 is connected to the output of the pulse generator 214 that generates a logic level pulse signal synchronized to the clock that is used to generate the ramp voltage and synch the PWM to it.

The output of AND gate 230 is provided as a PULSE_ON signal at node 232 to provide an indication of when a PWM pulse should be turned on. The PULSE_ON signal at node 232 controls the generation of the PWM pulse signal provided to the gate drivers responsive to the status of the COMP signal provided at node 222. The PULSE_ON signal is at a logical “high” level when it is determined that the voltage error signal provided at node 222 is above the ramp signal provided by pulse generator 214. The PULSE_ON signal provided at node 232 goes to a logical “low” level when it is determined that the voltage error signal provided at node 222 falls below the ramp signal provided from pulse generator 214.

Thus, the process for hysteretically determining whether the COMP voltage has exceeded the COMP_OUT voltage multiplied by the gain amplifiers 216 and 218, the relational operators 220 and 224 and the NAND gate 226. The gain amplifiers 216 and 218 along with the relational operators 220, 224 determine whether the COMP voltage has exceeded the hysteretic range established by the COMP_OUT voltage multiplied by the gains. When the COMP voltage exceeds the range established for the COMP_OUT voltage the logical output of the NAND gate 226 goes to a logical “high” level which causes the voltage regulator to initiate the PWM pulse provided from the output of the AND gate 230 in synch with clock (from pulse generator 214). This occurs when the logical output of the AND gate 230 goes to a high level.

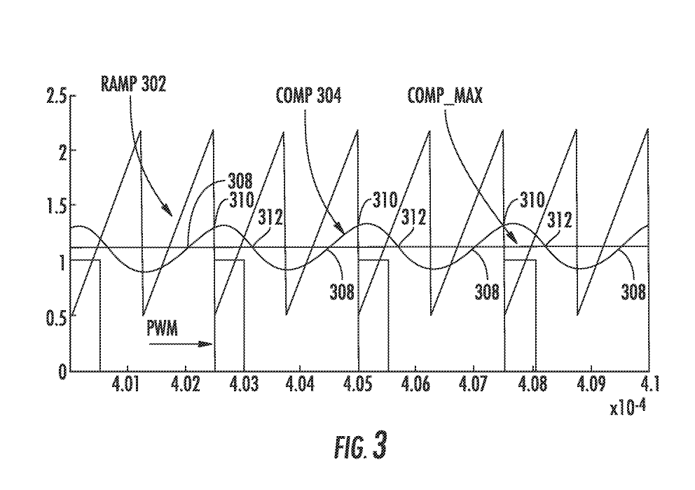

Referring now to FIG. 3, there is illustrated the generation of the various signals within the circuit of FIGS. 1 and 2. The ramp signal 302 is provided from the pulse generator circuit 214. The COMP signal 304 comprises the voltage error signal and is generated by the error amplifier 118 and provided at input node 222. The COMP_MAX signal 306 is a programmable signal established by the output of sample block 217. The PWM pulse is illustrated at the bottom of FIG. 3 and is provided at the output node 232. The circuitry of FIG. 2 enables the voltage regulator to run in a quasi-hysteretic manner. The voltage regulator enters the PFM mode at point 308 when the COMP signal 304 exceeds the programmed COMP_MAX signal 306 level. This is determined at the output of NAND gate 226 of FIG. 2. At point 310, the rising edge of the PWM pulse is initiated when the COMP signal 304 exceeds the ramp signal 302 while the system is in the PFM mode of operation as determined at AND gate 230. As long as the COMP signal 304 remains above the pre-programmed value of the COMP_MAX signal 306, the voltage regulator will remain in the PFM mode of operation and not returned to the diode emulation mode. The voltage regulator will enter the diode emulation mode and leave the pulse frequency modulation mode of operation when the COMP signal 304 falls below the ramp signal 302 and when the COMP signal falls below the COMP_MAX signal 306 at point 312. The voltage regulator will remain in the diode emulation mode of operation until the next time the COMP signal 304 exceeds the COMP_MAX level 306 at the next point 308.

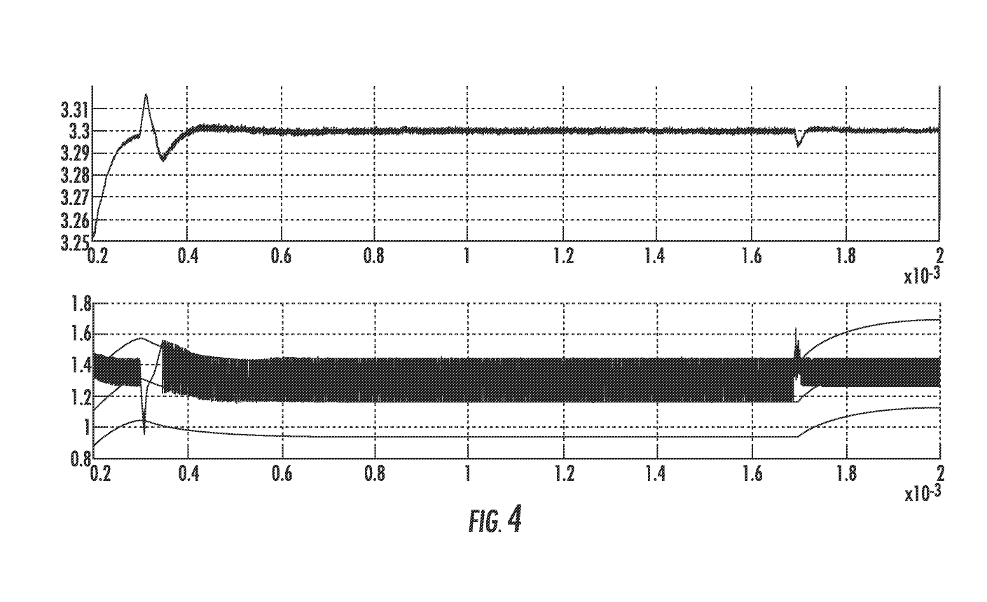

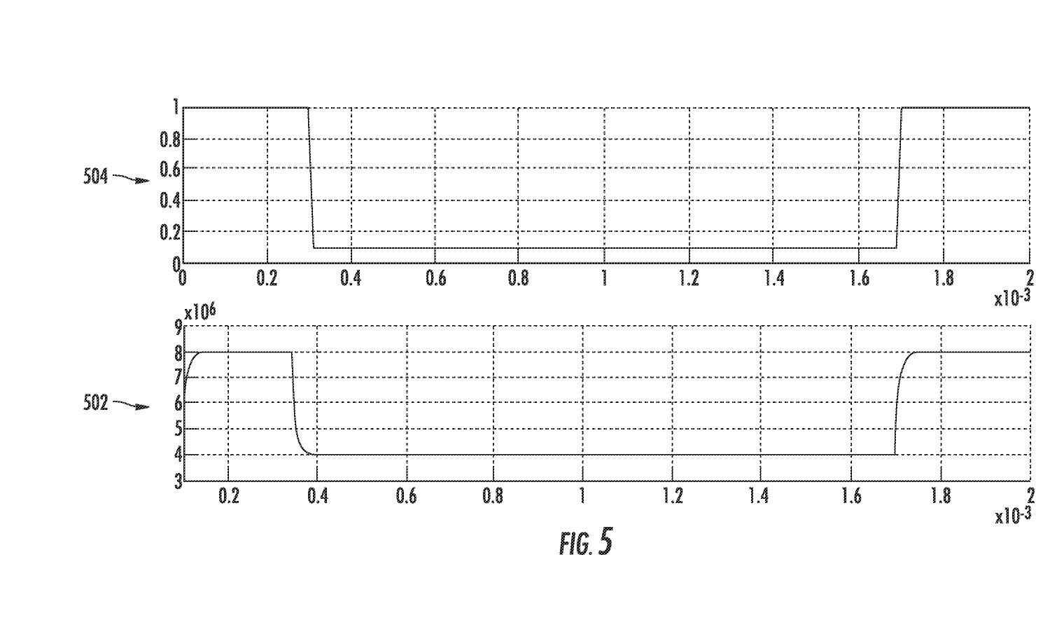

FIGS. 4 and 5, illustrate simulations of the operation of the circuit discussed with respect to FIGS. 2 and 3. In FIG. 4, there are illustrated the transition from pulse frequency modulation mode of operation to fixed frequency mode of operation. FIG. 5 illustrates the improvement in switching frequency when using the circuitry of FIG. 1 and 2. The bottom portion 502 illustrates the operation of a voltage regulator pulse width modulation signal that does not use the circuitry of FIG. 2. The upper portion 504 illustrates the operation of a voltage regulator using the circuitry of FIG. 2. Thus, using the above described circuitry of FIG. 2, the voltage regulator is able to operate in a quasi-hysteretic mode. When the load connected to the output voltage node of the voltage regulator is below a certain limit the voltage regulator will go into the pulse frequency mode of operation. A sample of the compensation pin output may be taken and an upper limit COMP_MAX based on the compensation pin sample selected. The regulator will then enter a diode emulation mode of operation. Once the COMP voltage signal rises above the established COMP_MAX level the PFM mode of operation is turned on. The PFM mode of operation is turned off when the COMP voltage falls below the RAMP voltage and the COMP_MAX level. Thus, the system is hysteretically turned on but is turned off based upon the ramp signal. Also, the linear loop is always in control of the regulator. Thus, when transients occur and the regulator needs to move from a PFM mode of operation to a non PFM mode of operation, the transition will only be based on the linear compensation of the system. An additional advantage of this scheme is the capability to synchronize the switching frequency to an external clock even during the PFM mode.

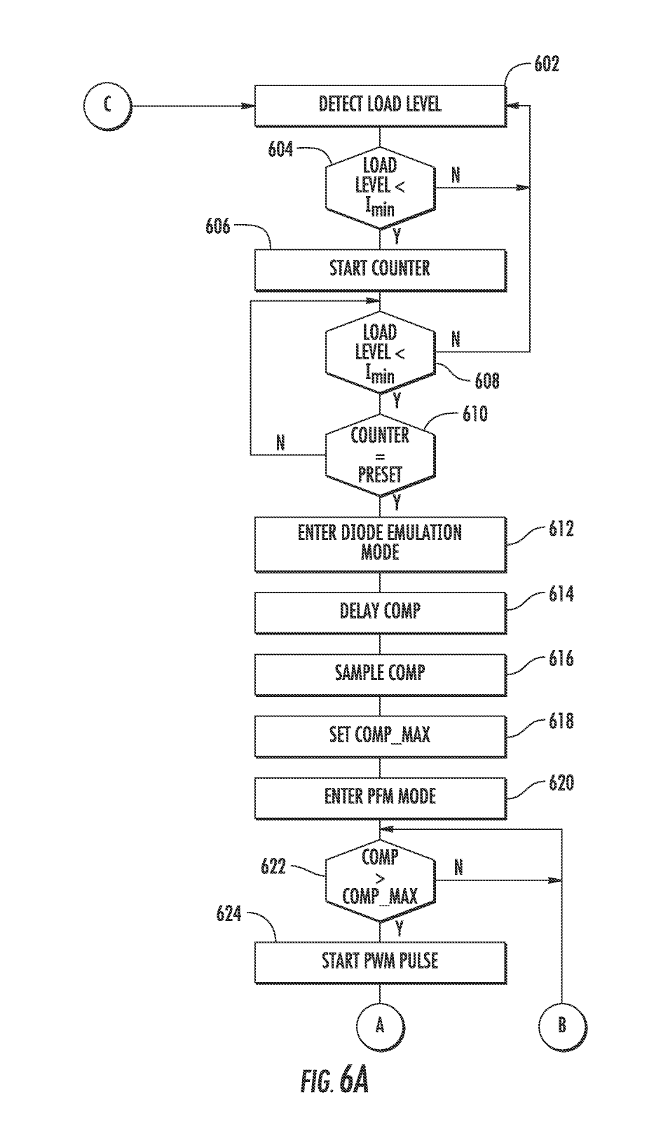

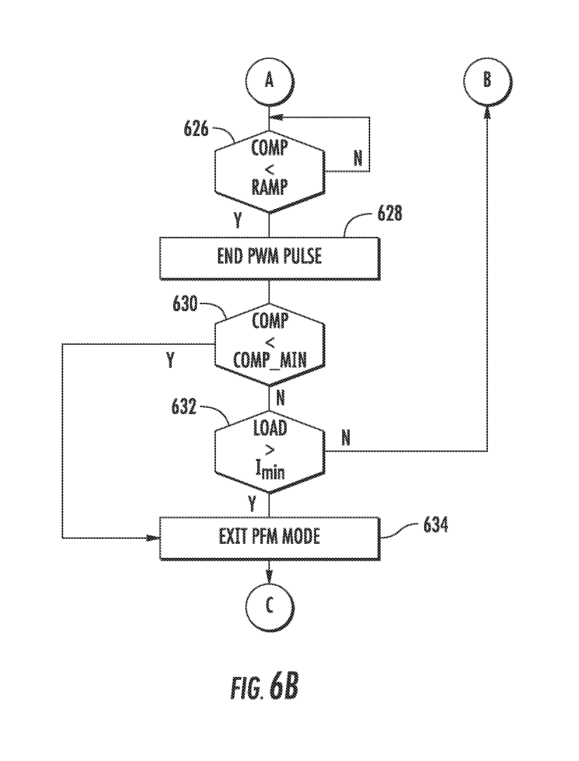

Referring now to FIGS. 6a and 6b, there are illustrated flow diagrams described in the operation of the circuitry of FIG. 2. Initially, the load level at the output node of the associated regulator circuit at step 602. Inquiry step 604 determines if the load level is less than desired minimum current level (IMIN). The minimum current level is set at a user programmed level. If the load level is not less than the minimum current level, control passes back to step 602. If inquiry step 604 determines that the load level is less than the minimum current level a counter is initiated at step 606.

Inquiry step 608 determines whether the load level is still less than the minimum current level IMIN. If not, control passes back to step 602. If the load level remains below the minimum current level IMIN, inquiry step 610 determines if the counter has been operating for a predetermined period of time. If not, control passes back to inquiry step 608. Once the counter reaches the predetermined period of time, the regulator enters the diode emulation mode at step 612 and the lower switching capacitor is turned off. The value of the COMP output is delayed at step 614, and the delayed COMP signal is sampled at step 616. Using the delayed COMP signal, the value of COMP_MAX is established at step 618. COMP_MAX may be set to a desired level, for example +30 mV. The regulator then enters the pulse frequency modulation (PFM) mode at step 620.

Inquiry step 622 determines if the COMP value is greater than the COMP_MAX value at the start of the applied ramp voltage. If not, the process continues to monitor at step 622 until the start of the next ramp voltage. If COMP is greater than the COMP_MAX value a PWM pulse is initiated at step 624. Inquiry step 626 determines if the COMP voltage is less than the applied ramp voltage. If not, inquiry step 626 continues to monitor the COMP signal with respect to the ramp voltage. When the COMP voltage is determined to fall below the ramp voltage, the PWM pulse is ended at step 628.

Inquiry step 630 determines if the COMP signal is less than the COMP_MIN value. COMP_MIN may be set to a desired level, for example −30 mV. If not, control passes to inquiry step 632 which determines if the load level is greater than the IMIN value. If the load value is greater than the IMIN value, control passes back to step 622. If either inquiry step 630 determines the COMP value is less than the COMP_MIN value or inquiry step 632 determines that the load value is greater than the IMIN value, the regulator exits the PFM mode at step 634 and control will pass back to step 602.

It will be appreciated by those skilled in the art having the benefit of this disclosure that this system and method for providing pulse frequency modulation mode provides a an improved system and method for controlling a pulse frequency modulation mode of operation. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A voltage regulator comprising:
switching circuitry for generating a phase voltage at a phase voltage node responsive to an input voltage and switching control signals;
an inductor connected to the phase voltage node and an output voltage node;
a capacitor connected between the output voltage node and ground;
an error amplifier for generating an error voltage responsive to an output voltage from the output voltage node and a reference voltage;
switching control circuitry for generating switching control signals to the switching circuitry responsive to the error voltage, a ramp voltage and an established voltage level, wherein the switching control circuitry operates the voltage regulator in a pulse frequency modulation mode of operation after sampling the error voltage and setting the established voltage level and exits the pulse frequency modulation mode of operation when the error voltage falls below the established voltage level.

2. The voltage regulator of claim 1, wherein the switching control circuitry generates a rising edge of a PWM signal responsive to the error voltage exceeding the ramp voltage.

3. The voltage regulator of claim 2, wherein the switching control circuitry generates a falling edge of a PWM signal responsive to the error voltage falling below the ramp voltage.

4. The voltage regulator of claim 1, wherein the switching control circuitry enters a diode emulation mode of operation after a load level at an output of the voltage regulator is less than a predetermined current level for a predetermined period of time.

5. The voltage regulator of claim 1, wherein the switching control circuitry delays the error voltage prior to sampling the error voltage.

6. The voltage regulator of claim 1, wherein the switching control circuitry exits the pulse frequency modulation mode of operation when the load level at an output of the voltage regulator is greater than the predetermined current level.

7. An integrated circuit for generating a phase voltage for a phase node of a voltage regulator, comprising:
switching circuitry for generating a phase voltage at a phase voltage node responsive to an input voltage and switching control signals;
an error amplifier for generating an error voltage responsive to an output voltage from the output voltage node and a reference voltage; and
switching control circuitry for generating switching control signals to the switching circuitry responsive to the error voltage, a ramp voltage and an established voltage level, wherein the switching control circuitry operates the voltage regulator in a pulse frequency modulation mode of operation after sampling the error voltage and setting the established voltage level and exits the pulse frequency modulation mode of operation when the error voltage falls below the established voltage level.

8. The voltage regulator of claim 7, wherein the switching control circuitry generates a rising edge of a PWM signal responsive to the error voltage exceeding the ramp voltage.

9. The voltage regulator of claim 8, wherein the switching control circuitry generates a falling edge of a PWM signal responsive to the error voltage falling below the ramp voltage.

10. The voltage regulator of claim 7, wherein the switching control circuitry enters a diode emulation mode of operation after a load current level at an output of the voltage regulator is less than a predetermined current level for a predetermined period of time.

11. The voltage regulator of claim 7, wherein the switching control circuitry delays the error voltage prior to sampling the error voltage.

12. The voltage regulator of claim 7, wherein the switching control circuitry exits the pulse frequency modulation mode of operation when the load level at an output of the voltage regulator is greater than the predetermined current level.

13. A method for operating a voltage regulator, comprising the steps of:
operating the voltage regulator in a diode emulation mode of operation;
sampling the error voltage and setting an established voltage level in the diode emulation mode of operation;
switching to a pulse frequency modulation mode of operation from the diode emulation mode of operation after sampling the error voltage and setting the established voltage level;
operating the voltage regulator in the pulse frequency modulation mode of operation; and
exiting the pulse frequency modulation mode of operation when the error voltage falls below the established voltage level.

14. The method of claim 13, wherein the step of operating in the diode emulation mode of operation further includes the step of entering the diode emulation mode of operation after a load current level at an output of the voltage regulator is less than a predetermined current level for a predetermined period of time.

15. The method of claim 13, wherein the step of switching to the pulse frequency modulation mode further comprises the step of delaying the error voltage prior to the step of sampling.

16. The method of claim 13 further comprising the steps of:
determining if the error voltage exceeds the ramp voltage; and
generating a PWM pulse responsive to a determination that the error voltage pulse exceeds the ramp voltage.

17. The method of claim 16 wherein the step of generating the PWM pulse further comprises the steps of:
generating a rising edge of the PWM pulse responsive to a determination that the error voltage exceeds the ramp voltage; and
generating a falling edge of the PWM pulse responsive to the determination that the error voltage falls below the ramp voltage.

18. The method of claim 13, wherein the step of exiting the pulse frequency modulation mode of operation further includes the step of exiting the pulse frequency modulation mode of operation when the load level at an output of the voltage regulator is greater than the predetermined current level.
